(19) United States
(12) Patent Application Publication
(10) Pub. No.: US 2011/0039997 A1
(43) Pub. Date: Feb. 17, 2011

(54) STABLE COMPOSITION FOR THE DETACHABLE ASSEMBLING OF SUBSTRATES BY GLUING

(75) Inventors: Eric Papon, Saint Magne De Castillon (FR); Jose Alcorta, Begles (FR); Maxime Olive, Talence (FR)

Correspondence Address: YOUNG & THOMPSON, 209 Madison Street, Suite 500, Alexandria, VA, 22314, US

(73) Assignee: RESCOLL, Pessac (FR)

(21) Appl. No.: 12/988,144

(22) PCT Filed: Apr. 14, 2009
(86) PCT No.: PCT/FR2009/050683

§ 371 Date: Oct. 15, 2010

(30) Foreign Application Priority Data
Apr. 15, 2008 (FR) 08 52504

(51) Int. Cl. C09J 175/04

(52) U.S. Cl. 524/172; 524/190; 524/590

(57) ABSTRACT

A composition designed for the detachable assembly of a first substrate and a second substrate by gluing, includes an adhesive polymer base and at least one active substance. The active substance is encapsulated in a wax matrix so as to prevent any reaction with the adhesive polymer material during the storage of the composition or during its implementation. A process for preparing this composition is also described.

This invention relates to a composition of stable formulation, designed for the on-demand detachable assembly of substrates by gluing and for a process for preparation of such a composition.

In the industry, there are numerous compositions designed for assembly by gluing that are perfectly suited to the conditions that are necessary for mechanical strength and for resistance to the temperatures that are undergone and to numerous other parameters that are both physical and chemical.

These compositions can consist of an adhesive polymer base and at least one specific substance that imparts particular characteristics to them.

In particular, compositions are known for the detachable assembly by gluing of two substrates that contain an active substance making it possible to detach two glued substrates without degrading them and without modifying the qualities of the adhesive. These compositions are described in particular in the patent application FR-2,877,349.

However, if these known compositions provide total satisfaction and are particularly suited to the assembly of substrates by gluing, their formulation can exhibit significant stability problems.

Actually, during the storage of the composition before its use, or during its implementation, the active substance has a tendency to react with the adhesive polymer base. The composition then loses its effectiveness and its use becomes difficult.

In the case of, for example, compositions that are described in the patent application FR-2,877,349, the incorporation of the active substance in the adhesive polymer base can bring about a very clear reduction in storage time (“shelf life”) or of setting time (“pot life”) of the adhesive, which can be manifested by a very quick gelling of the adhesive in its container. For example, when the composition is stored in a moisture-proof cartridge, as in the case of a single-component polyurethane, gelling of the adhesive is observed in less than one week.

Also, the purpose of this invention is to eliminate the drawbacks of the existing adhesive compositions that are designed for the detachable assembly of substrates by gluing, comprising a polymer base and at least one active substance, by proposing a composition that remains stable during storage and that does not modify the properties of the adhesive.

For this purpose, the invention has as its object a composition that is designed for the detachable assembly of a first substrate and a second substrate by gluing, comprising an adhesive polymer base and at least one active substance, characterized in that said active substance is encapsulated in at least one wax particle in such a way as to prevent any reaction with the adhesive polymer material during the storage of the composition or during its implementation.

Preferably, said active substance is microencapsulated in wax particles.

Wax particle is defined as any particle that consists of a wax matrix, coating material, containing the active substance.

The invention also covers a process for preparation of such a composition, comprising the following stages:
Encapsulation of an active substance in a wax matrix so as to obtain particles in which said active substance is contained, and
Incorporation of said encapsulated active substance in an adhesive polymer base.

Preferably, the encapsulation is a microencapsulation.

Microencapsulation is defined as any technology that makes possible the preparation of individualized microparticles, consisting of a wax matrix that contains an active material.

The invention is now described in detail.

The composition according to the invention comprises an adhesive polymer base and an active substance, designed to make the assembly detachable, encapsulated in one or more wax particles.

Wax or wax matrix is defined as all waxes, in particular the paraffin waxes (alkanes having a melting point of less than 100° C.) and polyolefin waxes, in particular polyethylenes (polyolefins having a melting point that can range up to 130° C.).

Preferably, it involves a wax based on one or more paraffins or polyethylenes.

Active substance is defined in particular as a chemical expansion agent.

According to one particularly suitable but nonlimiting embodiment, the active substance that allows the detachment is a migrating agent, i.e., an agent that, when the composition is used to form a seal between a first and second substrate, is able to migrate to at least one of the interfaces of said seal to generate a layer with low cohesion. When energy is supplied to the migrating agent that is incorporated in the seal, its migration to the interface of said seal with another seal or with a substrate is produced, thus generating a layer of low cohesion, making it possible to separate the elements facing the layer of low cohesion. According to one particularly suitable embodiment, this layer of low cohesion consists of a gas pocket that is generated by the decomposition of the active substance.

Preferably, the migrating agent is p-toluenesulfonylhydrazide (PTSH) or azodicarbonamide (ADC), which may or may not be accelerated.

The adhesive polymer base can be, for example, a single-component polyurethane that crosslinks with the moisture in the air.

The active substance is encapsulated in a wax matrix.

Preferably, the wax matrix is based on one or more paraffin(s) or one or more polyolefin(s). The polyolefins can be selected in particular from among polyethylenes.

Advantageously, the waxes, in particular the paraffins and polyolefins, have a low surface energy, which makes it possible for them to be hydrophobic and to ensure low affinity with the components of the glue.

The hydrophobic nature makes it possible to easily dry the formed particles.

The low affinity with the components of the glue makes it possible to limit the reactivity of these components and to improve the stability during storage. Actually, the active substance, isolated from its environment, does not react with the adhesive polymer base. The wax particles that encapsulate the active substance push back the adhesive, which prevents any premature reaction, while preserving the properties of the composition.

The composition can thus be stored for a minimum of 90 days without the adhesive running any risk of gelling.

In addition, the matrix of the particles being made of wax, it has totally melted at the activation temperature of the encapsulated substance and therefore does not present any obstacle to the free expansion of the active substance for allowing the disassembly, contrary to other polymer matrices.

The composition according to the invention can be obtained by a process that comprises the following stages:
Encapsulation, preferably microencapsulation, of an active substance so as to obtain wax particles in which said active substance is contained, and
Incorporation of said active substance that is encapsulated in an adhesive polymer base.

The encapsulation of the active substance can be achieved by different known techniques, in particular thermal gelling, the freezing of drops, simple or complex coacervation, evaporation of solvent, nebulization, coating in a fluidized bed or spheronization.

The process can be carried out in particular in water by thermal gelling with a wax that has a melting point of less than 95° C., such as a paraffin wax.

The process can also be carried out by drop freezing with a wax that has a higher melting point than the waxes that are used in water. This process is suitable in particular for glued assemblies that require a strength of several minutes and even several hours at temperatures of higher than 100° C. The drop freezing consists in cooling with air drops of the molten mixture of wax and active substance.

According to a particularly suitable embodiment, the encapsulation is carried out by thermal gelling. In particular, the encapsulation process for the preparation of the composition according to the invention comprises the following stages:
Adding a quantity of an active substance in the heated demineralized water,
Next, adding the same quantity of wax in the molten state and stifling, and then
Adding cooled demineralized water and stifling until the temperature is less than the melting point of the wax.

When the water-insoluble wax is added, it is dispersed in the form of micro-droplets in which the active substance will be concentrated. Then, when the mixture is cooled suddenly, the solidification of the wax provides microsphere-type solid particles into which the active substance is poured.

Advantageously, this process is easy to use in the laboratory and can be easily transposed to the industrial scale.

It is possible to provide a particular nonlimiting example of an encapsulation process for the preparation of a composition according to the invention comprising the series of the following stages:
Heating demineralized water,
Once the water is at the target temperature, adding the accelerated ADC while being stirred and continuing to stir,
Next, adding paraffin, for example a paraffin 70-80, in the molten state and continuing to stir,
Adding cooled demineralized water, whereby the mixing temperature has to drop below the melting point of the wax and then next stopping the stifling,
Filtering the mixture under vacuum and drying the solid with acetone for eliminating water, and then
Allowing the particles to dry in air.

The accelerated ADC that is encapsulated in paraffin is next incorporated in an adhesive composition with a single-component polyurethane base, for example putty for automobile windshields.

Tests have been conducted on a composition according to the invention in comparison to a composition of the prior art.

Three compositions are tested:
C1: Adhesive composition without active substance,
C2: Adhesive composition with non-encapsulated active substance, and
C3: Adhesive composition with encapsulated active substance according to the invention.

For each composition, the forced flow (in g/min) is measured before and after aging for 7 days at 40° C. The forced flow is measured at a pressure of 4 bar, a diameter of the hole of 4 mm, and a temperature of 23° C.

Starting from the values that are obtained, the variation of fluidity is then calculated.

The results that are obtained, expressed by percentage of variation, are presented in the table below:

| | Variation Before/After Aging (%) |
|---|---|
| Cl | 3% |
| C2 | 46% |
| C3 | <17% |

First of all, it is noted that the presence of an active substance in the composition C2 duly produces a very strong variation of fluidity after 7 days of storage at 40° C.

These results also show that this variation is considerably reduced with the composition C3 according to the invention. Advantageously, this invention thus prevents premature gelling of the adhesive during its storage.

1. Composition, designed for the detachable assembly of a first substrate and a second substrate by gluing, comprising an adhesive polymer base and at least one active substance that is designed to make the assembly detachable, characterized in that said active substance is encapsulated in at least one wax particle.

2. Composition according to claim 1, wherein the active substance is a migrating agent.

3. Composition according to claim 2, wherein the migrating agent is p-toluenesulfonylhydrazide.

4. Composition according to claim 2, wherein the migrating agent is azodicarbonamide.

5. Composition according to claim 1, wherein the adhesive polymer base is a single-component polyurethane.

6. Composition according to claim 1, wherein the wax matrix is selected from among paraffin-based waxes.

7. Composition according to claim 1, wherein the wax matrix is selected from among the polyolefin-based waxes.

8. Composition according to claim 7, wherein the wax matrix is selected from among the polyethylene-based waxes.

9. Process for preparation of a composition according to claim 1, wherein it comprises the following stages:
Encapsulation of an active substance, designed to make the assembly detachable, in a wax matrix so as to obtain particles in which said active substance is contained, and
Incorporation of said encapsulated active substance in an adhesive polymer base.

10. Process for preparation according to claim 9, wherein the encapsulation is a microencapsulation.

11. Process for preparation according to claim 9, wherein the encapsulation is implemented by thermal gelling.

12. Process for preparation according to claim 11, wherein the encapsulation comprises the following stages:
Adding a quantity of active substance designed to make the assembly detachable in the heated demineralized water,
Next, adding the same quantity of wax in the molten state and stirring,
Adding cooled demineralized water and stirring until the temperature is less than the melting point of the wax.

13. Process for preparation according to claim 9, wherein the encapsulation is carried out by the freezing of drops, simple or complex coacervation, evaporation of solvent, nebulization, coating in a fluidized bed or spheronization.

14. Process for preparation according to claim 10, wherein the encapsulation is implemented by thermal gelling.

15. Process for preparation according to claim 10, wherein the encapsulation is carried out by the freezing of drops, simple or complex coacervation, evaporation of solvent, nebulization, coating in a fluidized bed or spheronization.
